(19) United States
(12) Patent Application Publication
(10) Pub. No.: US 2007/0273643 A1
(43) Pub. Date: Nov. 29, 2007

(54) Dongle joystick

(75) Inventors: Eran Erez, Gedera (IL); Ran Carmeli, Rinatya (IL); Moshe Raines, Tel Aviv (IL); Yitzhak Pomerantz, Kfar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD.

(21) Appl. No.: 11/716,648

(22) Filed: Mar. 12, 2007

Related U.S. Application Data
(60) Provisional application No. 60/803,047, filed on May 24, 2006.

(51) Int. Cl. G09G 5/00

(52) U.S. Cl. 345/156

(57) ABSTRACT

A portable data storage device (dongle) is configured to serve as a joystick. A method and system are supplied for using the dongle joystick to modify the presentation of an a electric media content item over a host and for using the dongle joystick as a user input interface to select a content item to be presented over a host or to select a datum to be stored. One portion of the dongle joystick is connected to the host and held stationary while a user imposes a force on a second part of the joystick to select and play content. The dongle joystick may include a processor to process output into a format compatible with a legacy playing device host.

### FIELD AND BACKGROUND OF THE INVENTION

The present invention is a method and system to supply content to a host device and provide a user input interface to control the host by means of a single portable dongle. Particularly the dongle is used as a portable storage device and detachable user input device to the host.

Portable storage devices are used to transport data from one machine to another machine. For example, files are brought from one computer to another computer or electronic entertainment content is brought from a computer to a digital playing systems. As the internal storage capacity of portable data storage devices is large and growing, a portable storage device typically contains a plurality of content items. A user needs to browse, select, and play files contained in the storage device. The user also needs to modify (stop, restart, pause, fast forward, reverse, skip and adjust parameters) the play of a given file.

Traditionally, the host for a portable storage device is a programmable computer and the portable storage device serves to provide data to the computer. A typical computer includes a large array of programs for data interpretation and a range of dedicated user interface devices including input devices [for example a keyboard, a mouse and a joystick] and output devices [for example a display screen and loudspeakers]. As such, traditional portable storage devices have a fixed data format and depend on the host to solve compatibility issues, to perform data interpretation and to supply a flexible user interface that is adaptable to the particular needs of any content included in the portable storage device. A common example of a mobile storage device is a flash disk. A typical flash disk includes neither an internal power supply [for example a battery] nor a user interface output device [for example a display screen or speakers] nor a user interface input device [for example a touch screen, a keypad, a mouse, or a joystick]. As such, the flash disk has very small dimensions of 1″×0.25″×0.1″ or less, and thus the largest dimension is 1 inch or less, the second largest dimension is 0.25 inches or less and the maximum two-dimensional profile is 1×0.25=0.25 square inches or less. However, for a playing system that lacks the flexibility of a programmable computer, for example a digital TV, a car radio, or a legacy stereo system, the built-in user interface—even if it exists—has pre-designed functionality and cannot be adapted for use in new and different applications. Therefore, it is necessary to supply a more sophisticated user interface so that the user may modify presented content (for example browse, select, play, stop, restart, and execute content).

Prior art stand-alone digital players may be adaptable to legacy hosts [for example an MP3 player can be played over legacy speakers]. Such stand-alone players include a built in user interface. The built in user interface generally includes a display screen and an input device (for the smallest stand-alone players, the input device and display are both included in a touch screen). Examples of such players include a dedicated player (an MP3 player, an MP4 player or a Game Boy™) or a portable computing device (a PDA). The minimum size of a stand-alone player is limited by the minimum size of the user interface (screen and input area) for quick easy control. It is understood that there is a strict tradeoff between the size of the user interface (and therefore the player) and the quality and ease of input and output. Players having a built in interface are considerably bigger than a typical portable storage device having no display screen or keypad. For example, the Axia NFC (advertised as the worlds smallest PDA) has dimensions of 0.5″×1.5×4″ and a maximum 2D profile of 6 square inches. Similarly the PoGo Flipster (advertised as the worlds smallest MP4 player) has dimensions of 2.5″×3.5″×1″ thus the largest dimension is 3.5″, the second largest dimensions is 2.5″ and the maximum 2D profile is 8.75 square inches. Even the NEC N930 (advertised as the worlds smallest mobile phone) has dimensions of 3.5″×2″×0.4″ and a maximum 2D profile of 7 square inches. All these “super portable” players are much bigger than a typical flash disk as described above. Furthermore, a mobile player having advanced portable input and output systems is much more expensive than a simple mobile storage device. Furthermore, (as owners of MP4 players are well aware), small output area reduces the quality of the media display experience of a stand-alone portable player.

Even when a player having a built in user interface is configured for direct output to a host that plays output from the player (for example playing an MP3 player over external speakers), the user interface output device included in the stand alone player is used for selecting content and controlling play. The small size of the built in user interface makes it difficult for the user to discern and choose among multiple options. For example, anyone who has ever tried used a state of the art portable MP3 player or digital video camera knows that due to the small user output interface, a user who wishes to choose a song from a large collection of songs or to adjust a recording format is required to navigate a maze of interconnected menus using fine motor skills and a large number of highly coordinated hand/eye movements. Thus, it takes a long time to learn to use such a player and even for the experienced user, changing content or format can be a tedious experience and may be impractical under adverse conditions. Therefore, a user is prevented from enjoying quality electronic content in many situations, (for example in a car, boat, or public transportation etc) where a large programmable computing device is unavailable and environmental factors (noise, poor lighting, vibration or the attention requirements of the user [for example needing to pay attention to the road while driving a car]) make it difficult to work the user interface of a prior art portable player.

A joystick is a user interface input device commonly found on programmable computers. Joysticks are a very well known in computer engineering. In typical software applications, joysticks are used for navigation in menus, drawing, inputting commands and coordinates, and so on. Joysticks are easy to use, and have tactile feedback (tactile feedback means that the direction in which the joystick is pointing is tactilely perceptible [the user can feel the joystick] and a user does not need to pay visual attention [look at] the joystick during use).

There is thus a widely recognized need for, and it would be highly advantageous to have, a simple inexpensive small portable storage device that can be used with a wide variety of legacy host playing systems and can serve as a user input interface that does not require precision eye hand control to choose content and control play; while the legacy host output is used for user interface output. The present invention fulfills this need.

### SUMMARY OF THE INVENTION

The present invention is a method and system to provide a user input interface to control a host and preferably to supply content to the host by means of a single portable device. Particularly a dongle is used as a portable storage device and detachable user input device for the host. The dongle connects to a common stable socket and is compatible with a variety of host systems. Preferably, the storage device also acts as a joystick to conveniently control content and playing. Due to the simple nature of the joystick, the device is not significantly larger than a typical flash disk

According to the teachings of the present invention there is provided a portable data storage device for a host. The portable data storage device includes a connector configured to reversibly operationally couple the portable data storage device to a surface (the connector may include for example a plug that fits a socket or the connector may include a suction cup or a magnet, or a clamp or a pin). The portable data storage device also includes a non-volatile memory for storing an electronic content selected by a user (for example a user may store on the device a computer file or an electronic entertainment content item [for example an MP3 file or an MP4 file or a novel stored in portable document format, or a digital photograph], or raw output of another device [for example a microphone or a laboratory measuring device]). The portable data storage device also includes a sensor configured to produce an output according to a spatial relationship between a portion of the data storage device and the surface. The surface is specified both in spatial coordinates and orientation (for example orientation of the surface can be specified as the direction of a normal to the surface). Thus the spatial relationship includes one or more components of the displacement between the surface and the portion of the data storage device or the relative orientation of the portion of the portable data storage device with respect to the surface, or a change in the displacement (for example a reduction in magnitude of displacement when the portion moves closer to the reference point on the surface or a change in direction of displacement when there is a change in the angle of displacement) or orientation (for example the portion is rotated [twisted] but the displacement remains unchanged), or an acceleration of the portion of the portable data storage device relative to the surface (acceleration may be in the magnitude of the displacement [a linear acceleration towards or away from the surface] or in the direction of displacement [an increase or decrease in the rate of change of the angle of displacement] or in the orientation [an increase or decrease in the rate of change of the twisting {angle of orientation} of the portion] or a combination of these relations. For the sake of the present invention, a portion of the portable data storage device may be a location on the device, a surface associated with the device, a part of the device or the whole device. For the sake of the present invention, a displacement between a portion of the device and a surface may be defined as the distance from a first reference point fixed with respect to the portion to a second reference point fixed on the surface. According to this definition, the magnitude of displacement is the distance between the first and second reference points and the direction of displacement is angle of the vector joining the first and second reference points. (Alternatively, instead of angle and distance, a linear parameterization is within the scope of the present invention, for example a Cartesian parameterization defining the length of the directed distances in the three cardinal, x, y, z-directions). Alternatively distance between the portion and the surface can be defined as the shortest straight-line distance between any point within the portion and any point on the surface [in this case describing the displacement requires specifying the location of the closest point on the surface and the location of the closest point on the portion and specifying the displacement between the two closest points], or any other convenient measure. A measure of displacement may be parametric (for example an ordered set of numbers specifying the status (bent/straight) of a set of joints). The absolute location of the portion in space need not be known (for example, a joystick may have an unknown length {e.g. user adjustable or where a single sensor is used in more than one model of storage device}, the displacement between the distal end of joystick and the attachment point may be incompletely parameterized {measured} as the angle of a ball joint joining the joystick to the surface, in such a case one may know the measured displacement of the portion (the angle of the ball joint) without knowing the absolute location of the portion in space {because the absolute location of the portion also depends on the length of the joystick}.

According to the teachings of the present invention there is also provided a system for data storage. The system includes a portable data storage device and a non-volatile memory for storing a datum selected by a user. The system also includes a host having a surface to which the portable data storage device is reversibly operationally coupled (secured) using a connector, and the system includes a sensor configured to sense a spatial relation between a portion of the portable data storage device and the surface while the portable data storage device is reversibly operationally coupled to the surface.

According to the teachings of the present invention there is also provided a method for data storage (for the sake of the present invention data storage includes temporarily storing the data in order to transport the data to a new location or to a second device [the second device may be a host device or another device] and data storage also includes storing the data to facilitating future use of the data). The method includes the steps of coupling a portable data storage device to a surface on the host using a connector and sensing a spatial relation between a portion of the portable data storage device and the surface. The method also includes the steps of selecting a datum to be stored and storing the datum on a non-volatile memory of the portable data storage device.

According to the teachings of the present invention there is also provided a system for modifying the presentation of an electronic content item. The system includes a dongle joystick and a stable socket that is in communication with a host. The dongle joystick includes a connector that is configured such that while the connector is reversibly operationally coupled to the stable socket, the dongle joystick communicates with the host via the stable socket. Furthermore, the connector is configured such that while the connector is reversibly operationally coupled to the stable socket, a first portion of the dongle joystick is held effectively stationary in respect to the stable socket. The dongle joystick also includes a link joining a second portion of the dongle joystick to the first portion and a sensor configured to supply an output in response to a force affecting the link. Thus, when a user wishes to modify the presentation of the electronic media content item, the use applies a force to the second portion of the joystick. The force is transferred via the link to the first portion of the joystick. If the link is rigid, the force affects the link by creating a stress on the link or if the link is flexible the stress affects the link by causing flexing of the link and movement of the second portion of the dongle joystick with respect to the first portion. In either case (whether the link in rigid or flexible) the sensor registers the effect of the force on the link and produces an output. The presentation of the electronic media item is modified according to the output of the sensor. For example, the user may modify the presentation of a MP3 audio item by choosing an item to play, by starting play of an item, by stopping play of an item, by fast forwarding the item, by pausing play of the item or by changing the volume of play of the item. Similarly the user may modify play of a MP4 audio-visual item. The user may also employ the dongle joystick to modify the playing of a game (for example in the case of solitaire, the user may employ the dongle joystick to start the game, to stop the game, to adjust the playing level of the game, to choose a card, to turn over a card or move a card).

According to further features in preferred embodiments of the invention described below, the datum is transferred between the portable data storage device and a second device (for example a host device, the Internet, a receiver of a broadcast signal [for example a TV or a radio], or a media playing device [for example a tape deck or a VCR or a CD player]) according to an output of said sensor. Thus the user employs to the joystick to select the datum to store in the non-volatile memory or to transfer the datum to another device or to control the transfer of the datum.

According to still further features in the described preferred embodiments, the spatial relation is a direction of displacement of the portion with respect to the surface, a magnitude of displacement of the portion with respect to the surface, or an orientation of the portion with respect to the surface or a change in the above relations, or an acceleration of change of the above relations or a combination of the above relations.

According to still further features in the described preferred embodiments, the surface is located on a host (by on the host we intend that either the surface includes an external surface of the host or that the reference point is located at a point inside the host).

According to still further features in the described preferred embodiments, the host is configured to function by providing a service to the user. The service may include providing feedback to the user from the sensor, or reporting a contents of the non-volatile memory (for example to display an index of the names of files contained in the memory), or playing an electronic entertainment content item, or identifying a datum to be stored in the non-volatile memory (for example to display an attribute of the file containing the datum), or to report a state of the portable storage device [for example a state of the device may include how much free memory is available, whether the device is ready to disconnect, or whether the device is malfunctioning].

According to still further features in the described preferred embodiments, the electronic entertainment item that is played by the host is stored in the non-volatile memory of the portable data storage device.

According to still further features in the described preferred embodiments, the portable data storage device is configured such that the playing of the electronic media content is according to an output of the sensor. For example, the user employs the joystick to specify the playing volume, or a to select a content item to play.

According to still further features in the described preferred embodiments, the datum is selected by the user from a plurality of data by means of manipulating the portion of the joystick. Manipulating the portion can include applying a force to move the portion.

According to still further features in the described preferred embodiments, the portion is configured so that said user changes the spatial relation using only a gross motor activity.

According to still further features in the described preferred embodiments, the portable data storage device is also configured to serve as a USB-TV (a USB-TV is a dongle that stores electronic media content (the USB-TV program) [for example an MP4 file or other audio visual content] in a first format and outputs the content in a second format compatible to a second device so that the second device will display the broadcast the content [for example the content is a soap opera which is stored in a first format (an MP4 file) and the second device is a dumb TV set and the second format is an analogue TV signal that serves as input to the dumb TV set which displays the soap opera]).

According to still further features in the described preferred embodiments, the portable data storage device also includes a processor. The processor is configured to issue a command to the portable data storage device, to adjust a format of the datum (for example converting an MP3 file to an analogue signal for an audio device, or converting a file format), to issue a command to a second device [for example a host or an output device (for example when the user pushes up on the joystick, the processor sends to the host a command to move a cursor upwards)].

According to still further features in the described preferred embodiments, the sensor includes a one-dimensional bi-directional sensor, a momentary switch, a potentiometer, a shaft encoder, or a strain gauge

According to still further features in the described preferred embodiments, the method also includes the step of conveying to the user via the host playing system a menu containing a plurality of playing options, and the method also includes the step of the user applying a force to a second portion of the dongle. The force affects a link connecting the first portion of the dongle to the second portion of the dongle. Thus, the user selects one option from among the plurality of options according to the force that the user applies and the effect of that force on the link.

According to still further features in the described preferred embodiments, the stable socket is rigidly mounted onto the host, onto a piece of furniture (for example a table on which the host is placed, or a chair in which the user sits), onto a building (for example a wall or a floor), or onto a vehicle (for example the dashboard of a car or a boat).

According to still further features in the described preferred embodiments, a largest dimension of the dongle joystick is less than two inches.

According to still further features in the described preferred embodiments, a second largest dimension of the dongle joystick is less than one inch.

According to still further features in the described preferred embodiments, the dongle joystick lacks a display screen.

According to still further features in the described preferred embodiments, the dongle joystick lacks a keypad.

According to still further features in the described preferred embodiments, the force, which the user applies to the second portion of the dongle joystick, produces an effect that is tactilely perceptible to a user (for example bending the dongle joystick).

According to still further features in the described preferred embodiments, the dongle joystick is configured to facilitate the user's applying of the force necessary to control the host even when the user has a physical limitation. Particularly, when the physical limitation of the user (for example a lack of fine motor skills or uncontrollable trembling) inhibits the user from operating a native control (the originally supplied control) of the host (for example the tuning knob of a radio or a two way momentary switch mounted on a TV tuner for changing channels).

According to still further features in the described preferred embodiments, the dongle joystick also includes a wireless communication channel, and the dongle joystick is configured to serve as a user interface input device communicating directly to a third device via the channel. For example the dongle may include a wireless modem for communicating over the Internet. Using the wireless modem, the user enters a password directly to an Internet server. The host is completely blind to the password because the password is not entered into a user input device of the host and the password is not output from the host.

According to still further features in the described preferred embodiments, the dongle joystick is configured to serve as a pointing device.

According to still further features in the described preferred embodiments, the dongle joystick is configured for two-way communication with the host.

According to still further features in the described preferred embodiments, the dongle joystick is configured to receive authorization information from a user without revealing the authorization information to the host (the authorization information is not entered into a user input device of the host and the host is not utilized to output the authorization information).

According to still further features in the described preferred embodiments, the socket is a USB socket.

According to still further features in the described preferred embodiments, the force applied by the user affects the link by causing a deflection of the second portion of the dongle joystick with respect to the first portion thereof, or by causing a deflection of the second portion of the dongle joystick with respect to the stable socket, or by causing a stress on the link, or by causing a strain on the link, or by causing a pressure on the link.

According to still further features in the described preferred embodiments, the force is applied by a gross motor activity of a user (for example the user may push the dongle joystick with his whole hand, or he may push the dongle joystick with his foot).

According to still further features in the described preferred embodiments, the method of modifying playing of a media content item also includes the step of providing a feedback. For example the host may include a display screen and supply a visual feedback on the screen showing the identity (filename or content label) of a selected MP4 file. The host may include a loudspeaker and provide audio feedback (for example a clicking sound may be made each time a new option is selected, and the tone of the click may signify the direction of the browsing (which depends on the direction of the force that is applied by the user). For example, a high tone means that the new item selected is higher on the list than the previous item selected (which means that the user is pressing upward on the dongle), while a low tone means that the new item selected is lower on the list than then previously selected item (which means that the user is pressing downward on the dongle). The feedback may also identify to the user the magnitude of the force being applied to the dongle. For example, the rate at which the selection changes may be dependent on the magnitude of force on the dongle and thus the rate of clicking sounds or the rate of change of the displayed selected option is then the feedback which the users employs to know the magnitude of the force that is being applied to the dongle. The host my identify click or the color of the displayed selection may identify to the user the magnitude of the force on the dongle.

### Terminology

For the sake of the present invention, the following definitions are used:
Electronic media content item—content transferred via an electronic media (examples include: a stored computer program, a stored computer game, input data for a program, text in a file, data in a file, a recording [analogue or digital], or an item intended for presentation to a human [e.g. sound on an MP3 file, video on an MP4 file, a slide presentation, a picture, sound picked up by a microphone, images picked up by a video recorder, sound picked up by a telephone, sound broadcast by a radio, images broadcast on in a TV signal]).
Force—a linear force or a twisting moment in any direction.
Joystick—a manual device sensitive to directional pressure for supplying input to, controlling, and commanding an electronic system.
Dongle—a device, which is small in relation to a host, rigidly or semi-rigidly supported by a socket of the host, containing data storage.
Host—an electronic device that accommodates a dongle via a socket; typically the host is much larger than the dongle.
Stable socket—a coupling suitable for accepting, a mating connector, the coupling providing an electrical or communication connection to a host and also supplying stable mechanical support to the connector so that slight force or moment applied to the connector does not affect the connection and does not significantly change the physical position of the connector (the connector remains effectively stationary) with respect to the socket. Most sockets on prior art panels are stable under this definition. For the sake of this patent, a socket is not limited to a hollow receptacle and a connector does not necessarily fit inside the socket,
Gross motor activity—an action performed by a person without independent control of a proper subset of the five fingers of one of the person's hands. For example, according to this definition, shifting gears with a stick shift in a manual transmission automobile is defined as a gross motor activity while changing from drive to reverse with a floor mounted shifter in an automatic transmission automobile requires fine motor skills (because a button must be pushed with the thumb in one direction while the rest of the hand moves the shifter in a second direction), also turning a bicycle is a gross motor activity while turning a knob on a radio requires fine motor skills.
Keypad—an input device, consisting of a grid of at least 3 numerical, alphabetical or function keys arranged for efficient data entry.
Display screen—a part of an electronic device that is capable of showing an arbitrary numeric or alphabetic character.
Selectable content—a plurality of data items, in which each item is accessible upon request by a user.
Momentary switch or button—a switch or button that returns to its normal position when released.
Pointing device—a hardware component that allows a user to input spatial data to an electronic device; the data may be interpreted by a Graphical User Interface (GUI) to allow the user to control and provide data to the device using physical “gestures” (for example point, click, and drag); feedback to the user may be provided by a graphical representation on the screen of movements of a cursor; feedback to the user also may be provided by other cues including visual and audio cues (for example a synthesized voice or a clicking sound representing movement between menu items); common pointing device include a mouse, a tracker ball, a trackpad, a lightpen, a digitizing tablet and a “data glove”.
Portable—a device is described as portable if it is small enough and light enough to be carried in a typical adult pants pocket.
Surface—a surface is a two-dimensional structure in three-dimensional space defining a position in space and an orientation. (For example, orientation may be defined by a vector normal to the surface at a fixed reference point.) For the sake of the present invention, the surface may be real surface of a physical object (for example the faceplate of a TV set) or a hypothetical surface (for example the xy-plane associated with a set of fixed Cartesian axes); the surface may be flat, curved, smooth, continuous, bumpy or discontinuous.
Spatial relation—a spatial relation between two objects may include a distance (magnitude of displacement) between the two objects, a direction of displacement, or a relative orientation between the objects (for example the attitude {pitch yaw and roll} of an aircraft is the relative orientation of the aircraft with respect to the ground). Typically a spatial relation is measured in terms of a coordinate system. The coordinate system may be extrinsic (for example Cartesian, spherical or cylindrical), parametric (Parametric coordinates are an ordered set of numbers that specify a position. The ordered set can have an arbitrary number of members (for example, in an embodiment in which the joystick has four joints, the displacement of the free end of the joystick is parameterized by an ordered quadruple specifying the angle of each joint) or intrinsic. Axes are typically but not necessarily normal to each other. A spatial relation may be cardinal (describing the absolute relation between the objects) or ordinal (describing a change in a cardinal spatial relationship or a rate of change of a cardinal spatial relationship or an acceleration of change of a cardinal relation).
Displacement—For the sake of the present patent, a displacement is a vector (having length and direction) joining two objects. The displacement may be specified by any convenient parameterization. A magnitude of the displacement may be specified by any convenient measure.

### BRIEF DESCRIPTION OF THE DRAWINGS

The invention is herein described, by way of example only, with reference to the accompanying drawings, where:

FIG. 1 is a side view of a first embodiment of a host attached to a dongle joystick.

FIGS. 2a-2d are side views of a second embodiment of a dongle joystick, the second embodiment being controlled by folding an appendage

FIG. 3a is a front view of a conventional computer monitor serving as host for a dongle joystick of a third embodiment of the present invention.
FIG. 3b is a detailed cutaway view of the dongle joystick of the third embodiment of the present invention.

FIG. 4a is a three-dimensional view of an adaptor used in a fourth embodiment of the present invention

FIG. 4b is a flowchart showing a method of supplying an input to a host according to the fourth embodiment of the present invention.

FIG. 5 illustrates a fifth embodiment of the present invention in which the dongle joystick is made of a flexible material.

### DESCRIPTION OF THE PREFERRED EMBODIMENTS

The principles and operation of a dongle joystick according to the present invention may be s better understood with reference to the drawings and the accompanying description.

The present invention is a system and a method for user input to a host by means of a dongle connected to a stable socket on the host. The dongle functions as a joystick and is mechanically supported by the socket. The socket grips a connector of the dongle and holds the connector steady while the user manually applies force to the body of the dongle. A sensor registers the force and relays an output to the host. The output varies according to the direction and magnitude of the force. The host interprets variations in the sensor output and effects a particular command associated with a particular output of the sensor.

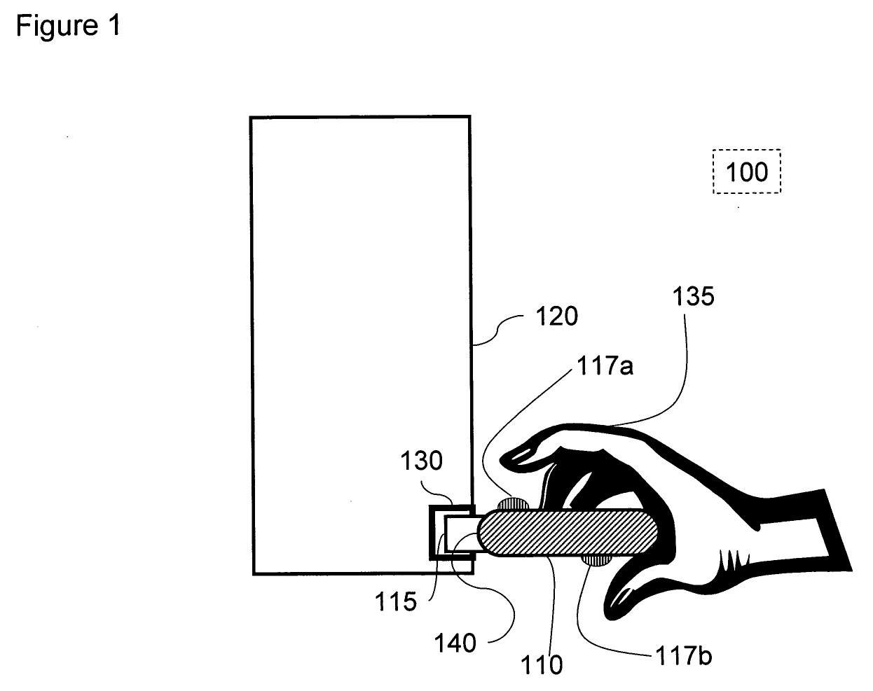

Attention is now called to FIG. 1: a side view of a first embodiment 100 of the present invention. In FIG. 1, a host 120 is a TV set. A socket 130 is rigidly mounted onto host 120. Socket 130 is a stable socket, which grips [stabilizes by applying a force and a moment] a connector 115 of dongle joystick 110 thereby coupling dongle joystick 110 to the outer surface of host 120. Socket 130 also serves as a data connection between dongle joystick 110 and host 120. A user inputs commands to host 120 by applying a force to dongle joystick 110 with the user's hand 135. The force is counteracted by a force and a moment on socket 130 so that dongle joystick 110 remains effectively steady. Thus, when user hand 125 applies a force to dongle joystick 110, link 140 is affected by an applied stress. The direction (up, down, left, right) and magnitude of stress on link 140 is detected by sensors in link 140 of dongle joystick 110. Output of the sensors of link 140 provide information that is translated by a processor in dongle joystick 110 into digital commands or into X and Y coordinates on a screen of host 120. The digital commands are presented to host 120 in a format adapted to host 120. Thus, dongle joystick 110 can be used with a variety of hosts without requiring loading of drivers into the host. Furthermore, dongle joystick 110 can be used with a variety of non-programmable dumb hosts by automatically adjusting the output format of dongle joystick 110 to be compatible with the particular host. In a preferred embodiment of the present invention, the dongle joystick automatically senses the input format of the host and adjusts the output format automatically (transparently in regards to both the host and the user).

Alternatively, output of the sensors can be directed directly to the host to be interpreted by a processor of the host. In such an alternative embodiment, the host includes a processor and driver routines to facilitate interpretation of sensor output.

The conversion of directional pressure on the Dongle Joystick into graphical commands to move a cursor on a screen is performed in a way similar to the operation of the TrackPoint™ pointing device found in IBM™ notebook computers as produced by IBM™ Almaden Research Center, 650 Harry Road, San Jose, Calif. 95120-6099.

In addition to positioning the cursor on the screen, dongle joystick 110 also enables the user to provide commands, similar to clicking on buttons on a computer mouse or a joystick. This is done by providing momentary buttons 117a and 117b that are operated by the user once the cursor has been positioned on the proper menu item.

Alternatively host 120 may have a built in input device (for example a keyboard). In such a case the user interface will include both dongle joystick 110 and the host input device. Input from the host input device may provide a direct interface between host 120 and the user, or the host input device may be used as a user interface to a processor contained in dongle joystick 110. In the later case, communication between host 120 and dongle joystick 110 is two-way. Similarly, when there is two-way communication between host 120 and dongle joystick 110, a processor or data storage in host 120 may send commands or supply data to dongle joystick 110.

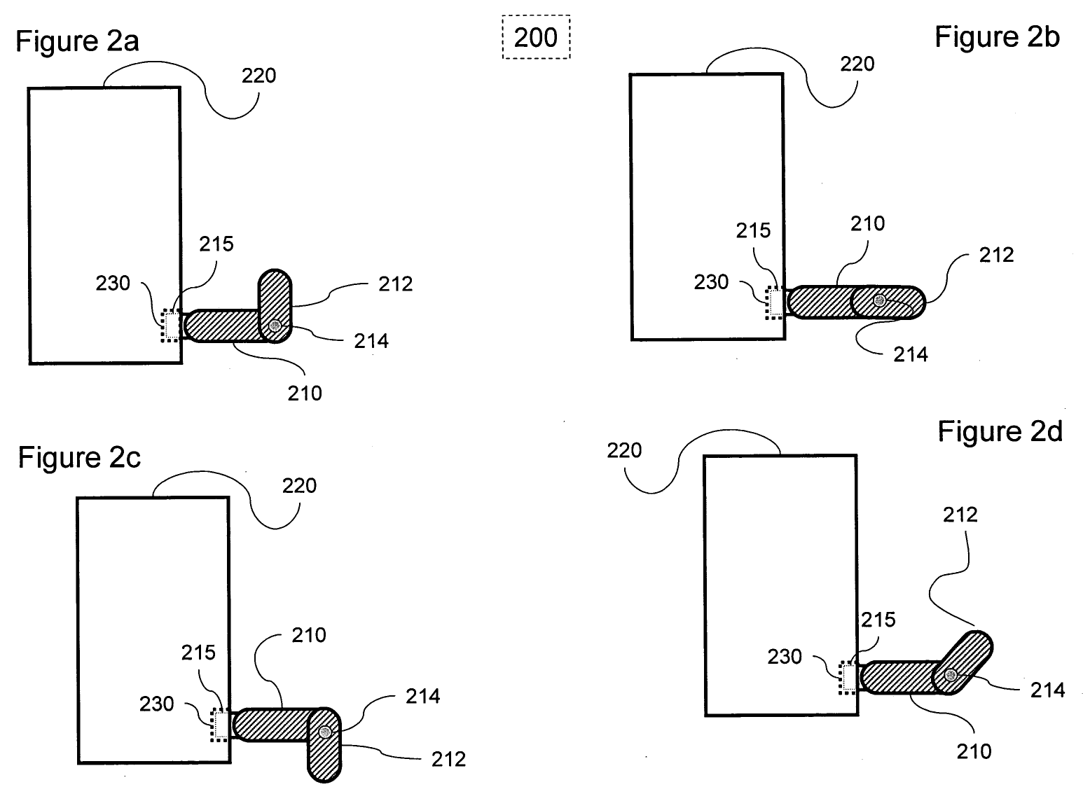

FIGS. 2a, 2b, 2c and 2d show a second embodiment 200 of a dongle joystick 210. In embodiment 200, dongle joystick 210 includes a connector 215, which is stably connected to a host 220 and mechanically supported (held effectively steady for commonly encountered forces) by a socket 230. Socket 230 is rigidly mounted in the front plate of host 220. Alternatively, socket 230 may be rigidly mounted onto a piece of furniture (for example onto desk or onto the hand rest of a chair in which the user sits) or socket 230 may be rigidly connected onto a building (for example socket 220 may be built into a power strip which is mounted on an office wall) or socket 230 may be rigidly mounted onto a vehicle (for example onto the dashboard of a car). Dongle Joystick 210 includes an appendage 212. Connector 215 and the first portion of dongle joystick 210 are connected to a second portion of dongle joystick 210, appendage 212, by a link which is a hinged micro switch 214. A cursor moves on a display of host 220 according to the output of hinged micro switch 214. Particularly, the cursor moves according to the geometric relationship between a first part of dongle joystick 210 (connector 215) and a second portion of dongle joystick 210 (appendage 212). A user controls movement of the cursor by mechanically deflecting appendage 212 to an appropriate angle. Each of FIG. 2a, FIG. 2b, FIG. 2c and FIG. 2d shows appendage 212 at a particular angle.

When appendage 212 is deflected in an upward direction as shown in FIG. 2a, the cursor moves upward at a constant velocity. To stop movement of the cursor, appendage 212 is returned to the fully straight position (FIG. 2b). When appendage 212 is deflected in a downward position (FIG. 2c), the cursor moves downwards at a constant velocity. When appendage 212 is deflected at a 45-degree angle upward (FIG. 2d), the cursor moves upward at a reduced velocity.

In embodiment 200 the configuration of appendage 212 is sensed using hinged micro switch 214. Alternatively, dongle joystick 210 may include a potentiometer, a shaft encoder, a momentary switch, one or more one-dimensional bi-directional sensors or a strain gauge to sense—in a discrete or analog way—the deflection of appendage 212 relative to the first portion of dongle joystick 210 or to sense a stress or strain on the dongle. The use of such sensor is well known in the art of joystick design and is similar to an ordinary joysticks, such those available from Happ®, 106 Garlisch Drive, Elk Grove, Ill. 60007, USA.

One who is skilled in the art will be aware that controlling dongle joystick 210 does not require fine motor skills (separate control of individual fingers). Rather appendage 212 can be moved by means of gross motor activity [for example pushing appendage 212 with a whole hand]. Furthermore, a user can tactilely perceive the configuration of dongle joystick 210 (meaning that the user can determine whether appendage 212 is in the up, down or straight position by feel without having to look at dongle joystick 210 or host 220). Furthermore, while dongle joystick 210 is mechanically supported by socket 230, dongle joystick 210 can be controlled using one hand. Thus, dongle joystick 210 can be employed conveniently by a user whose attention is occupied, for example a driver.

Alternatively, dongle joystick 210 may be customized for the needs of a particular user. Thus, buttons can be located on the joystick to accommodate use by a left-handed user. Similarly, the joystick can be designed to facilitate access by a physically limited user (whether the user be limited due to a physical handicap or due to the configuration of vehicle that the user is driving or due to an environmental factor [for example due to severe cold the user is required to wear thick gloves]). Thus, a dongle joystick according to the present invention can provide access for a handicapped user to multiple devices without needing a built in custom interface on each device. For example a person lacking fine motor skills, who is inhibited from operating at dial or a key pad, can use the present invention to view movies on a TV set or listen to music on a hi fidelity sound system without requiring use of the native controls of each of these devices, which include a dial that requires fine motor skills.

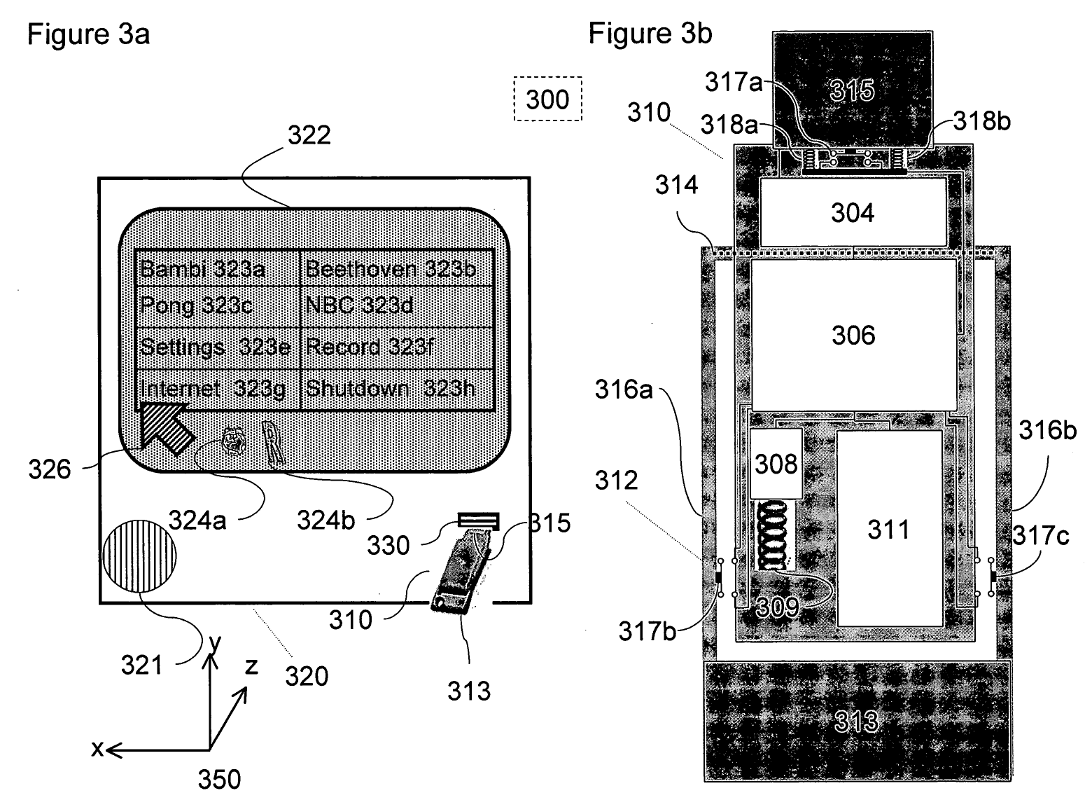

FIG. 3a and FIG. 3b show a third embodiment 300 of the present invention. FIG. 3a illustrates a host 320, which is a conventional computer monitor equipped with a USB socket 330. Host 320 includes a built in speaker 321, a display screen 322 and other controls and indicators typical to computer monitor (not shown). Host 320 also includes USB socket 330 rigidly mounted on the front panel of the monitor for connecting the monitor to a computer. When a dongle joystick 310 of the present invention is plugged into socket 330, dongle joystick 310 provides graphical data to host 320 in the same form as a conventional desktop computer. For example, in FIG. 3a dongle joystick 310 commands host 320 to display an initial menu of options including text menu items 323a-h and icons 324a-b. Particularly, there is a cursor 326 whose movement is controlled by a four-way switch 312 (see FIG. 3b) to choose an option. Alternatively, host 320 may itself have a means to show a cursor 326 responsive to information arriving from dongle joystick 310. The means for displaying a cursor on the screen are known in the art and are found in any personal computer. Examples of host devices that supply a means to show a cursor include but are not limited to a DVD player, a MP4 player and a computer game.

In the example of embodiment 300 the user chooses text menu item 323a to watch a movie (Bambi) or chooses text menu item 323b to listen to music (Beethoven) or chooses text menu item 323c to play a game (pong) or chooses text menu item 323d to watch a network telecast over the Internet (the NBC news) or chooses text menu item 323e to adjust the settings of dongle joystick 310 or chooses text menu item 323f to record a telecast or chooses text menu item 323g to browse the Internet or chooses text menu item 323h to shut down dongle joystick 310 permitting safe removal of dongle joystick 310 from host 320. Choosing is accomplished by using four-way switch 312 to direct cursor 326 to the desired item and clicking momentary switch 317a to make the choice. Dongle Joystick 310 also includes a second portion 313 whose function is described below.

Attention is now directed to FIG. 3b, which is a detailed cutout view of dongle joystick 310 of third embodiment 300 of the present invention. Dongle joystick 310 includes a processor 306, which acts as a microcomputer, processing commands and receiving user input. Output of processor 306 goes to a graphics card 304, which translates graphics commands into standard input form for a variety of host devices and send the output to a USB connector 315 which is a first portion of dongle joystick 310. In the example of embodiment 300, graphics card 304 outputs VGA graphics data to a standard computer monitor such as host 320. Graphics card 304 can also output standard television signals for a legacy dumb TV set. Graphics card 304 also outputs standard audio formats for input to audio devices (alternatively dongle joystick 310 may also include an earphone jack for audio output in addition to connector 315). Thus in the example of embodiment 300 data is transferred from dongle joystick 310 to host 320 in the form of graphics commands or digital or analogue image data. In an alternative example dongle joystick 310 can be connected to a desktop computer and data can be transferred as files either from the desktop computer to dongle joystick 310 or from dongle joystick 310 to the desktop computer.

Connected to processor 306 is also a non-volatile memory 311. Alternatively, non-volatile memory 311 may be a removable memory card that fits reversibly into a standard slot that is built into dongle joystick 310 (for example an SD memory card and slot). Thus, in embodiment 300 as illustrated in FIGS. 3a and 3b, along with programs necessary to drive dongle joystick 310, volatile memory 311 includes the following data: a web browser program, an MP4 version of the movie Snow White, a MP3 version of Beethoven's 5^{th} symphony, and a program to drive the game pong. User input to processor 306 is supplied by momentary switch 317a. Particularly, connector 315, is connected to the body of dongle joystick 310 via a momentary switch 317a and springs 318a and 318b such that when connector 315 is held effectively stationary by socket 330, and the body of joystick dongle 310 is pushed toward socket 330, the body of dongle joystick 310 moves in the direction of connector 315 closing (clicking) momentary switch 317a.

User input to processor 306 is also supplied by four-way switch 312. As explained below, four-way-switch is operated by deflecting second portion 313. Four-way switch 312 is a momentary switch which functions similarly to a standard four-way momentary-micro-switch (as included on many prior art mobile phones) allowing a user to input directional information. In previous art mobile phones a four-way-switch is operated with the thumb of a user (by pressing the edges of the switch) while the phone is held in the palm of the user's hand. As will be clarified below, due to the larger size and freer movement of second portion 313 of dongle joystick 310 in comparison to the four-way momentary-micro-switch of a prior art mobile phones it is possible (when connector 315 is held effectively stationary by socket 330) for a user to operate four-way-switch 312 and momentary switch 317a with one hand using only gross motor activity. Particularly, when connector 315 is inserted into socket 330 horizontally into the page (as shown in FIG. 3a) then four-way-switch is operated by pushing second portion 313 up, down, left, or right; whereas momentary switch 317a is operated (clicked) by pushing second portion 313 (or the body of joystick 310) into the page.

Four-way-switch 312 includes semi-flexible plastic arms 316a and 316b, momentary switches 317a and 317b, and a spring-hinged micro-switch 314. Semi-flexible plastic arms 316a and 316b are made of slightly flexible plastic. Thus semi-flexible plastic arms 316a and 316b remain stiff to a force applied along the arms, but semi-flexible plastic arms 316a and 316b bend when a strong moment is applied. Therefore when second portion 313 is pressed directly forward (in FIG. 3a this is into the page [in the positive z direction as shown in axes 350]) then semi-flexible plastic arms 316a and 316b remain straight and force is applied to the body of dongle joystick 310 closing momentary switch 317a. On the other hand, when a moment is exerted on semi-flexible plastic arms 316a and 316b by pushing second portion 313 to the side, semi-flexible plastic arms 316a and 316b bend until the force is removed at which time semi-flexible plastic arms 316a and 316b return to their original straight shape. Particularly, if a rightward force (in the negative x direction in FIG. 3a) is applied to second portion 313, then Semi-flexible plastic arms 316a and 316b bend rightward and momentary switch 317b is closed. If a leftward force is applied to second portion 313, then momentary switch 317c is closed. Upward and downward deflections (in the positive and negative y directions of FIG. 3a) of second portion 313 are registered by spring-hinged micro-switch 314 which is similar to hinged micro-switch 214 except that spring-hinged micro-switch 314 is a momentary switch with a spring that automatically returns spring-hinged micro-switch 314 to the straight position when no force is applied. The stiffness of semi-flexible plastic arms 316a and 316b is chosen such that the moment needed to work spring-hinged micro-switch 314 is less then the moment needed to bend semi-flexible plastic arms 316a and 316b.

The link between second portion 313 and connector 315 includes four-way-switch 312 and momentary switch 317a. Applying a force to second portion 313 affects the link by bending semi-flexible plastic arms 316a-b or by moving the body of dongle joystick 310 towards connector 315 (thereby closing momentary switch 317a) or by causing a vertical deflection (working spring-hinged micro-switch 314). One who is skilled in the art of mechanical/electrical switches will understand that there are many alternative methods to measure deflections of second part 313.

Connected to processor 306 are also a wireless modem 308 and an antenna 309 to permit direct communication between dongle joystick 310 and a third device over the Internet (direct communication means that signals pass directly from the user through dongle joystick 310 to the internet without passing through the host system) via a wireless communication channel (examples of a third device include the computer of the user's bank or an email server). Thus, the user can fill out an Internet form using dongle joystick 310 as a user input device directly to the Internet without passing personal information through (either the processor, or the user interface of) the host device. Authorization information for the Internet is stored in non-volatile memory 311. In embodiment 300, user authorization to dongle joystick 310 is supplied by a “password code” entered by pressing a string of commands via four-way switch 312 and momentary switch 317a. For example the password entry sequence for a particular user could be push up on four way switch 312 press momentary switch 317a three times and press right on four-way switch 312. Alternatively along with or in place of a password, authorization information may include biometric data (for example a fingerprint or a voice print) supplied by a measuring device or other authorization information known in the art. It will be clear to one skilled in the art that use of a simple switch for both user authorization and user input makes dongle joystick 310 smaller and less expensive than a dongle including a dedicated authorization interface.

One who is skilled in the art will note that dongle joystick 310 does not include an internal power source (for example a battery). This is due to the fact that dongle joystick 310 is designed to plug into self-powered USB socket 320 from which dongle joystick 310 receives power. This lack of internal power source allows further miniaturization of dongle joystick 310.

Alternatively, dongle joystick 310 may include a USB-TV tuner and deliver to host 320 a broadcast television content item.

It will be understood that dongle joystick 310 enables a considerable improvement in security over prior art devices. Particularly, in many applications [for example bank machines, computers labs (as in Universities), and Internet cafes, a user must transfer passwords to protected accounts through the local computer/interface. This leads to a possibility of identity theft. Therefore, prior art security dongles have been developed wherein possession of the dongle (with or without a password entered through the local system) constitutes user authorization. Prior art security dongles can be stolen and since the user password is still not protected from the local user interface, there is still a chance of identity theft. Using dongle joystick 310 the user password is transmitted directly from dongle joystick 310, which is in constant possession of the user, to the user's Internet server and never passes through a third party local computer or user interface; thus offering better protection from identity theft.

It will also be understood, that dongle joystick 310 allows a supplier (for example a internet cafe or a university computer lab) to give access to a high quality dumb user interface (input and output) without exposing the supplier's computer to computer viruses or pirate programs.

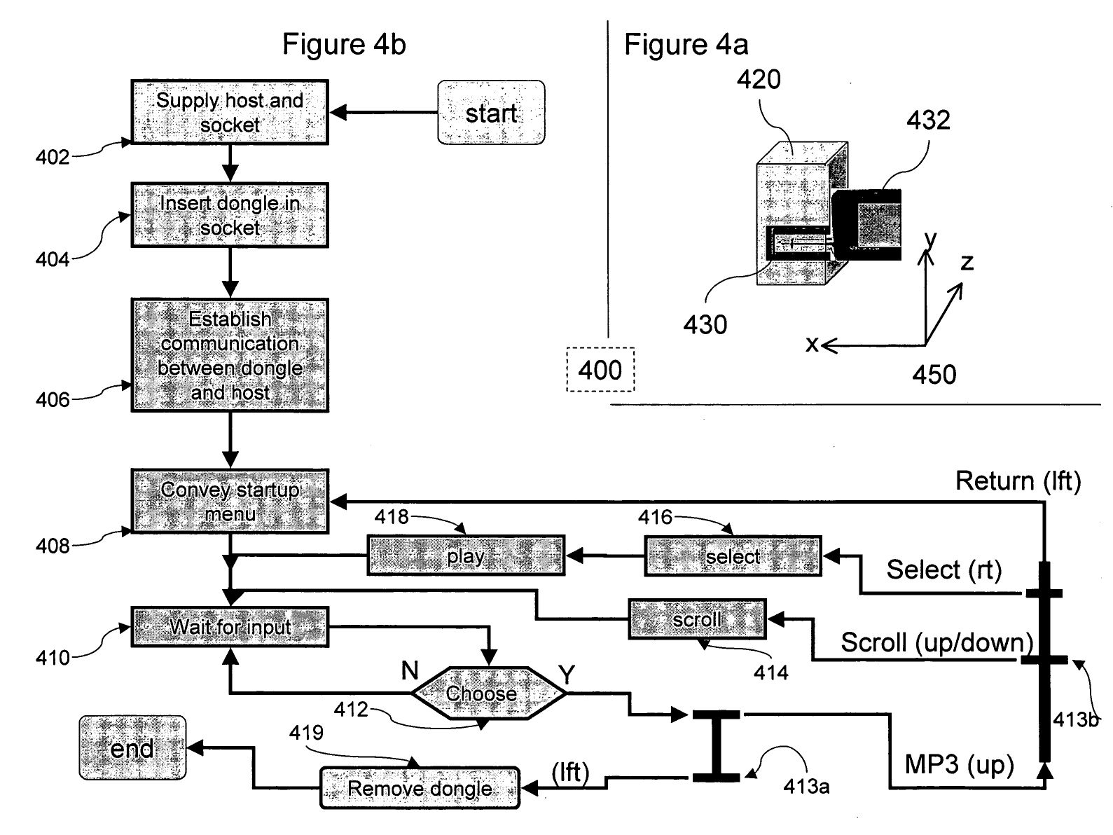

Attention is now directed to FIG. 4a, which is an illustration of an adaptor 432 which serves as a stable socket in a fourth embodiment 400 of a dongle joystick according to the present invention. In example of the fourth embodiment a host 420 is legacy electronic sound system (capable of producing hi fidelity sound but having no native programmability or information processing capacity).

The method of operation of embodiment 400 is illustrated in the flow chart of FIG. 4b. The first step is supplying 402 (FIG. 4b) the host system including a stable socket (in this case a ordinary microphone jack 430 and adapter 432) for dongle joystick 110 of FIG. 1. For clarity, a set of axes is depicted 450 where the positive x-direction is leftward along the page, the positive y-direction is vertically upward along the page and the positive z-direction is into the page. Thus inserting 404 dongle joystick 110 into host 420 consists of the steps of plugging dongle joystick 110 into adapter 432 and plugging adapter 423 into jack 430 of legacy stereo system, host 420. Once adapter 432 is plugged into microphone jack 430, jack 430 mechanically supports adapter 432 (and dongle joystick 110) by preventing translation of adapter 432 along the front panel of host 420 (in either the y or z-directions). Jack 430 also prevents translation in the positive x-direction beyond the point of maximum insertion into host 420. Because jack 430 includes a spring contact, jack 430 also provides resistance to translation in the negative x-direction (out of the host panel). Thus, adaptor 432 is rigidly mounted onto host 420 in the y direction, in the z direction and in the positive x direction (meaning moving adaptor 432 in the positive or negative y direction or in the positive or negative y-direction or in the positive x direction will also move the host) and adaptor 432 is not rigidly mounted onto host 420 in the negative x direction (meaning that pulling adaptor 432 in the negative x direction will move adapter 432 independently of host 420). On the other hand, because the legacy microphone jack 430 is round (unlike more modern stable sockets such as USB socket 330), jack 430 can rotate around the axis of the insertion hole. Nevertheless, this does not cause difficulty to a user because the top and bottom of dongle 110 is easily tactilely perceptible (a user can feel that dongle 110 is right-side-up because top button 117a is near the insertion point and bottom button 117b is near the back of dongle 110).

Unlike USB socket 320, jack 420 does not supply electrical power to dongle joystick 110. Thus, in the example of embodiment 400, dongle joystick 110 includes an internal power source (for example a miniature battery or a DC power input jack that can be connected via a transformer to normal line current in a house or to a car cigarette lighter). It is emphasized that dongle joystick 110 requires less power than an ordinary miniature computing device or even an MP3 player because dongle joystick 110 does not include a back lighted display screen. Therefore, even in the case where dongle joystick 110 includes a battery, the battery is smaller and lasts longer than the battery of a prior art portable player.

In an alternative embodiment, dongle joystick 110 does not have its own power supply, but is externally powered by adapter 432. In such a case adapter 432 would include an internal power supply (a battery) or an external power supply (for example via a DC adapter).

Since legacy audio device, host 420 has no processing ability, all processing and messaging is preformed transparently and internally by dongle joystick 110 and host 420 is blind to all processing and messages. All output of dongle joystick 110 is interpreted as a conventional electronic audio signal.

Once the physical connection between dongle joystick 110 and host 420 has been made, communication is established 406 between dongle joystick 110 and host 420. In the example of embodiment 400, communication is one way (dongle joystick 110 sends electronic signals to host 420 and the signals are broadcast as sounds over a loudspeaker, but dongle joystick 110 does not receive signals back from host 420). Therefore, the user must manually command dongle joystick 110 to begin functioning in a legacy audio connection mode by simultaneously pressing buttons 117a and 117b.

Alternatively adapter 432 may also include a signaling system, which signals to dongle joystick 110 that dongle joystick 110 is connected to a legacy audio device (thus automating the establishment 406 of communication and making it unnecessary for the user to press a button in order to establish communication).

After the connection is established 406 the user signals to dongle joystick 110 by pressing button 117b (serving as a menu button). Dongle joystick 110 then conveys 408 a startup menu to the user. Because host 420 does not have any visual display, the menu is conveyed 408 audibly. Particularly, in the example of embodiment 400, dongle joystick 110 syntheses a voice menu stating, “Main menu: up to play an MP3 file, Down to play a Wav file, left to disconnect, right for setup menu.” The main menu is represented in FIG. 4 by menu tree 413a. Dongle joystick then waits 410 for user input. The user may now modify the presented content (for example he can change the presented content between a content item or a menu, or he can start, stop or change the parameters of play of a content item).

The user chooses 412 to browse MP3 files by applying an upward force to the back of dongle joystick 110. Upon sensing the effect of the force (upward stress) on link 140, dongle joystick 110 reads the name of the first (in alphabetical order) MP3 file in the storage of dongle joystick 110 and synthesizes the voice message, “Bach Eine Kleine Nacht Music, right to play, up to next song, down to previous song, left to return to main menu.” The menu of MP3 options is represented in FIG. 4 by menu tree 413b. The user then scrolls 414 to the next song by pushing down on dongle joystick 110. Upon sensing an downward strain, dongle joystick 110 reads the name of the next MP3 file and synthesizes the voice “Beethoven symphony 5, right to play, up to next song, down to previous song, left to return to main menu.” The user selects 416 Beethoven's fifth by pressing right on dongle joystick 110 and dongle joystick 110 synthesizes the announcement “up increase volume, down decrease volume, right fast forward, left rewind, top button pause, bottom button return to MP3 scroll menu” and plays 418 the file by transferring the data, a conventional analogue electronic audio signal, across USB connector 115 and adapter 432 to socket 430 and host 420. Host 420 amplifies the signal and passes it to loudspeakers creating the desired sound.

While Beethoven's fifth is playing, dongle joystick 110 continues to wait 410 for a signal from the user. While music is playing, the user may increase volume by pushing up on dongle joystick 110, or the user may decrease volume by pushing down on dongle joystick 110 or the user may fast forward by pushing right on dongle joystick 110 or the user may rewind by pushing left on dongle joystick 110. The user may also pause by pushing top button 117a. The user may also return to the previous menu (the MP3 scroll menu) by pushing bottom button 117b.

Continuing the example of the operation of embodiment 400 the user presses bottom button 417b. Upon sensing that button 417b has been depressed dongle joystick 110 synthesizes the message announcing the current file and options, “Beethoven symphony 5, right to play, up to next song, down to previous song, left to return to main menu.” The user chooses 412 to end the session by pressing left on dongle joystick 110. Dongle joystick 110 then powers down and the user removes dongle joystick 110 from adapter 432.

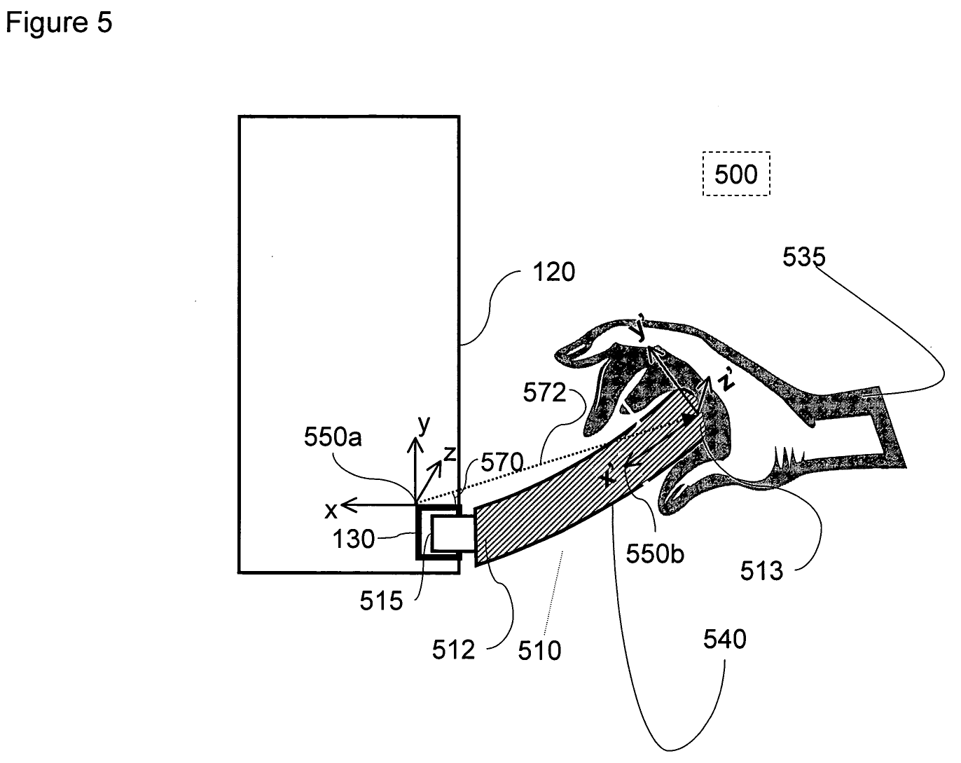

Attention is now called to FIG. 5, which illustrates a fifth embodiment 500 of a dongle joystick 510 according to the present invention. In the example of embodiment 500 dongle joystick 510 is reversibly operatively connected to host 120 of FIG. 1 via stable socket 130. The intermediate portion of dongle joystick 510 is flexible and thus acts as a link 540 joining a proximal portion 512 of dongle joystick 510 to a distal portion 513. The material of the body of dongle joystick 510 (including proximal portion 512, link 540, and distal portion 513) is made of a flexible material whose electrical properties change with stress. A set of electrode sensors measures these changes in electrical properties. Connector 515 and proximal portion 512 are held effectively stationary by socket 130. Thus, when a user 535 deflects (pulls, pushes or twists by applying a force or moment to) distal portion 513, stress is applied to link 540 causing a change in electrical properties. Each deflection of distal portion 513 (twisting or bending of link 540) produces a corresponding output pattern from the set of electrode sensors. The sensors of link 540 provide information that is translated by a processor in dongle joystick 510 into digital commands or into X and Y coordinates on a screen of host 120.

For example, the flexible material of link 540 may be wound of multiple pressure sensitive fibers that change conductivity in reaction to strain. Electrode pair sensors measure conductivity on various axes across link 540. A distinctive pattern of changes in conductivity is produced by each displacement of distal portion 513. Each pattern of conductivity changes brings about a distinctive pattern output across various electrode pairs. For example bending downwards results in compression on the lower side of link 540 and stretching on the uppers side. Pressure sensitive conductive flexible materials and sensors suitable for use in dongle joystick 510 exist in the previous art for example as disclosed in U.S. Pat. Nos. 5,652,395 and 4,988,981 and in US patent application 2006/0107762 and such a material (marketed as a Bend Sensor®) is available from Flexpoint Sensor Systems, Inc. 106 West 12200 South Draper, Utah 84020.

Because proximal portion 512 is held effectively stationary with respect to stable socket 130 therefore by detecting bending of link 540 the sensors of dongle joystick 510 also detect the spatial relation between a surface on host 510 (for example the surface is marked by axes 550a which is associated with a hypothetical surface defined as the xy-plane of axes 550a) and distal portion 513. Axes 550a and therefore the surface defined as the xy-plane of axes 550a are fixed in relation to stable socket 130 which is in turn fixed in relation to the front panel of host 120. The magnitude of the displacement (distance) between the surface (the xy-plane of axes 550a) and distal portion 513 is defined as the linear distance between a reference point on the surface (the origin of axes 550a) and distal portion 513. Thus, when no force is applied to dongle joystick 510, dongle joystick 510 is straight and the magnitude of the displacement is the unstressed length of dongle joystick 510. In its unstressed state, dongle joystick 510 is straight. Therefore, in the unstressed state, the direction of displacement between the surface and distal portion 513 is the axes of stable socket 130 (which is the negative x direction of axes 550a). When a force is applied to distal portion 513 (as shown in FIG. 5) then spatial relationship between the surface and distal portion 513 is that the displacement is in the direction of angle 570 in the xy-plane and the distance (magnitude of the displacement) is the length of line 572 (which is slightly less than the unstressed length of dongle joystick 510), and the orientation of distal portion 513 has been rotated around the z′ axis as is shown by axes 550b. When a user twists dongle joystick around the x′ axis then the orientation of distal portion 513 changes, but the displacement between the surface and distal portion 513 remains unchanged. It will be appreciated by one skilled in the art that any convenient measure of location and orientation may be used. For example displacement may be defined in Cartesian coordinates. Alternatively, displacement may be defined in a spherical coordinate system (a radial distance and two angles) or a cylindrical coordinate system (distance from a planar surface and angle and radial coordinate to the closest point on that surface) or alternatively a coordinate system may be related to an intrinsic coordinate system related to dongle joystick 510. For example displacement may be defined in terms of a radius of curvature, an orientation of bending and a degree of compression (defining the curvilinear length of dongle joystick 510).

While the invention has been described with respect to a limited number of embodiments, it will be appreciated that many variations, modifications and other applications of the invention may be made.

What is claimed is:

1. A portable data storage device comprising:
a) a non-volatile memory for storing a datum selected by a user;
b) a connector for reversibly operationally coupling the portable data storage device to a surface, and
c) a sensor configured to sense a spatial relation between a portion of the portable data storage device and said surface while said connecter is reversibly operationally coupled to said surface.

2. The portable data storage device of claim 1, wherein said datum is transferred between the portable data storage device and a second device according to an output of said sensor.

3. The portable data storage device of claim 1, wherein said spatial relation includes at least one relation selected from the group consisting of a direction of displacement of said portion with respect to said surface, a magnitude of displacement of said portion with respect to said surface, an orientation of said portion with respect to said surface, a rate of change of a magnitude of displacement of said portion with respect to said surface, a rate of change of a direction of displacement between said portion and said surface, a rate of change of an orientation of said portion with respect to said surface, an acceleration of said portion with respect to said surface.

4. The portable data storage device of claim 1, wherein said surface is located on a host.

5. The portable data storage device of claim 4 wherein said host is configured to serve a function including at least one function selected from the group consisting of providing a feedback to said user from said sensor, reporting a contents of said non-volatile memory, playing an electronic entertainment content item, identifying said datum, and reporting a state of the portable storage device.

6. The portable data storage device of claim 5, wherein said electronic entertainment item is stored in said non-volatile memory.

7. The portable data storage device of claim 5, further configured such that said playing is according to an output of said sensor.

8. The portable data storage device of claim 1, wherein said datum is supplied by at least one source selected from the group consisting of a host, the Internet, an input communicated via said sensor, a VCR, a microphone, and a broadcast signal.

9. The portable data storage device of claim 1, wherein said datum is selected by said user from a plurality of data by means of manipulating said portion.

10. The portable data storage device of claim 1, wherein said portion is configured so that said user changes said spatial relation using only a gross motor activity.

11. The portable data storage device of claim 1, further configured to serve as a USB-TV and wherein said datum includes a USB-TV program.

12. The portable data storage device of claim 1, further comprising:
d) a processor configured to perform at least one function selected from the group consisting of adjusting a format of an output of the portable data storage device, adjusting a format of said datum, and issuing a command to a second device.

13. The portable data storage device of claim 1, wherein said sensor includes at least one apparatus selected from the group consisting of a one-dimensional bi-directional sensor, a potentiometer, a shaft encoder, and a strain gauge.

14. A system for data storage comprising:
a) a portable data storage device including a non-volatile memory for storing a datum selected by a user;
b) a host including a surface, said portable data storage device being reversibly operationally coupled to said surface using a connector, and
c) a sensor configured to sense a spatial relation between a portion of said portable data storage device and said surface while said portable data storage device is reversibly operationally coupled to said surface.

15. The system of claim 14, wherein said datum is transferred between said portable data storage device and a second device according to an output of said sensor.

16. The system of claim 14, wherein said spatial relation includes at least one relation selected from the group consisting of a direction of displacement of said portion with respect to said surface, a magnitude of displacement of said portion with respect to said surface, an orientation of said portion with respect to said surface, a rate of change of a magnitude of displacement of said portion with respect to said surface, a rate of change of a direction of displacement between said portion and said surface, a rate of change of an orientation of said portion with respect to said surface, an acceleration of said portion with respect to said surface.

17. The system of claim 14 wherein said host is configured to serve a function including at least one function selected from the group consisting of providing a feedback to the user from said sensor, reporting a contents of said non-volatile memory, playing an electronic entertainment content item, identifying said datum, and reporting a state of said portable storage device.

18. The system of claim 17, wherein said electronic entertainment item is stored in said non-volatile memory.

19. The system of claim 17, wherein said portable data storage device is configured such that said playing is according to an output of said sensor.

20. The system of claim 14, wherein said datum is supplied by at least one source selected from the group consisting of a host, the Internet, an input communicated via said sensor, a VCR, a microphone, and a broadcast signal.

21. The system of claim 14, wherein said datum is selected by said user from a plurality of data by means of manipulating said portion.

22. The system of claim 14, wherein said portion is configured so that said user changes said spatial relation using only a gross motor activity.

23. The system of claim 14, wherein said portable data storage device is configured to serve as a USB-TV and wherein said datum includes a USB-TV program.

24. The system of claim 14, further comprising:
d) a processor contained in said portable data storage device, said processor being configured to perform at least one function selected from the group consisting of adjusting a format of an output of said portable data storage device, adjusting a format of said datum, and issuing a command to a second device.

25. The system of claim 14, wherein said sensor includes at least one apparatus selected from the group consisting of a one-dimensional bi-directional sensor, a potentiometer, a shaft encoder, and a strain gauge.

26. A method for data storage comprising the steps of:
a) coupling a portable data storage device to a surface using a connector;
b) sensing a spatial relation between a portion of said portable data storage device and said surface;
c) selecting a datum;
d) storing said datum on a non-volatile memory of said portable data storage device.

27. The method of claim 26, further comprising the step of:
e) Performing an action according to an output of said step of sensing, said action including at least one action selected from the group consisting of transferring said datum between said portable data storage device and a host, selecting said datum, transferring said datum between said portable storage device and a second device, and playing an electronic media content item.

28. The method of claim 26, wherein said step of sensing a spatial relation includes at least one action selected from the group consisting of sensing a direction of displacement of said portion with respect to said surface, sensing a magnitude of displacement of said portion with respect to said surface, sensing an orientation of said portion with respect to said surface, sensing a change in a magnitude of displacement of said portion with respect to said surface, sensing a change in a direction of displacement between said portion and said surface, sensing a change in an orientation of said portion with respect to said surface, sensing an acceleration of said portion with respect to said surface.

29. The method of claim 26 further comprising the step of
e) functioning of a host, said functioning including at least one service selected from the group consisting of providing a feedback to a user from said step of sensing, reporting a contents of said non-volatile memory, playing an electronic entertainment content item, identifying said datum, and reporting a state of said portable storage device.

30. The method of claim 29, wherein said datum is an electronic entertainment item.

31. The method of claim 29, wherein said playing is according to an output of said step of sensing.

32. The method of claim 26, wherein said step of selecting a datum is from a source including at least one source selected from the group consisting of a host, the Internet, an input communicated via said sensor, a VCR, a microphone, and a broadcast signal.

33. The method of claim 26, wherein said step of selecting is performed by a user through manipulating said portion.

34. The method of claim 26, further including the step of
e) changing by a user of said spatial relation through only a gross motor activity of said user.

35. The method of claim 26, wherein said portable data storage device serves as a USB-TV and wherein said datum includes a USB-TV program.

36. The method of claim 26, further comprising the step of:
e) adjusting a format of an output of said portable data storage device using a processor contained in said portable data storage device.

37. The method of claim 26, further comprising the step of:
e) adjusting a format of said datum using a processor contained in said portable data storage device.

38. The method of claim 26, further comprising the step of:
e) issuing a command to a second device using a processor contained in said portable data storage device.

39. A system comprising:
a) a host;
b) a stable socket configured to support communication with said host;
c) a dongle joystick including:
(i) a connector configured to facilitate communication with said host via said stable socket wherein while said connector is reversibly operationally coupled to said stable socket a first portion of said dongle joystick is held effectively stationary in respect to said stable socket;
(ii) a link joining a second portion of said dongle joystick to said first portion, and
(iii) a sensor configured to supply an output in response to a force affecting said link;
wherein a presentation of an electronic media content item on said host is modified according to said output of said sensor.

40. A method for modifying a presentation of an electronic media content item to a user comprising the steps:
a) connecting a dongle to a host playing system via a stable socket, said stable socket holding stationary a first portion of said dongle with respect to said stable socket;
b) conveying to the user via said host playing system a menu containing a plurality of playing options, and
c) applying of a force by the user to a second portion of said dongle, said force affecting a link connecting said first portion to a second portion of said dongle, whereby one option from among said plurality of options is selected according to said affecting.
